(19) United States
(12) Patent Application Publication
(10) Pub. No.: US 2022/0342773 A1
(43) Pub. Date: Oct. 27, 2022

(54) GLOBALLY UNIQUE WAY TO IDENTIFY A RESOURCE

(71) Applicant: EMC IP Holding Company LLC, Hopkinton, MA (US)

(72) Inventors: Asif Khan, Bangalore (IN); Jayashree B. Radha, Bangalore (IN); Ashish Kumar, Bangalore (IN); Pati Mohan, Bangalore (IN); Pawan Singh, Bangalore (IN); Yasemin Ugur-Ozekinci, Oakville (CA); Shelesh Chopra, Bangalore (IN); Amrit Lal Jain, Irvine, CA (US)

(21) Appl. No.: 17/236,032

(22) Filed: Apr. 21, 2021

(51) Int. Cl. G06F 11/14

(52) U.S. Cl. CPC G06F 11/1469; G06F 11/1464; G06F 11/1466; G06F 11/1451

(57) ABSTRACT

A method for providing data protection services to service devices that provide computer implemented services for clients and host resources used to provide the computer implemented services to the clients includes obtaining a resource discovery request for a service device of the service devices. The method further includes, in response to obtaining the resource discovery request: identifying a resource of a portion of the resources hosted by the service device; obtaining: a system identifier for the resource, and a natural identifier for the resource; making a determination that the natural identifier matches a second natural identifier associated with a known resource of the known resources; and in response to the determination: updating a record associated with the known resource based on one or more conditions of the resource.

### BACKGROUND

Computing devices may provide services. To provide the services, the computing devices may include hardware components and software components. The software components may store information usable to provide the services using the hardware components.

### SUMMARY

In one aspect, a backup management system for providing data protection services to service devices that provide computer implemented services for clients and host resources used to provide the computer implemented services to the clients in accordance with one or more embodiments of the invention include storage for storing: a discovered resource repository that specifies known resources of the resources and a naming repository that specifies how natural identifiers are generated. The backup management system also includes a processor that obtains a resource discovery request for a service device of the service devices; in response to obtaining the resource discovery request: identifies a resource of a portion of the resources hosted by the service device; obtains: a system identifier used by the service device to identify the resource, and a natural identifier of the natural identifiers for the resource using the naming repository; makes a determination that the natural identifier matches a second natural identifier associated with a known resource of the known resources; and in response to the determination: updates a record of the discovered resource repository associated with the known resource based on one or more conditions of the resource.

In one aspect, a method for providing data protection services to service devices that provide computer implemented services for clients and host resources used to provide the computer implemented services to the clients in accordance with one or more embodiments of the invention includes obtaining a resource discovery request for a service device of the service devices; in response to obtaining the resource discovery request: identifying a resource of a portion of the resources hosted by the service device; obtaining: a system identifier for the resource, and a natural identifier for the resource; making a determination that the natural identifier matches a second natural identifier associated with a known resource of the known resources; and in response to the determination: updating a record associated with the known resource based on one or more conditions of the resource.

In one aspect, a non-transitory computer readable medium in accordance with one or more embodiments of the invention includes computer readable program code, which when executed by a computer processor enables the computer processor to perform a method for providing data protection services to service devices that provide computer implemented services for clients and host resources used to provide the computer implemented services to the clients. The method includes obtaining a resource discovery request for a service device of the service devices; in response to obtaining the resource discovery request: identifying a resource of a portion of the resources hosted by the service device; obtaining: a system identifier for the resource, and a natural identifier for the resource; making a determination that the natural identifier matches a second natural identifier associated with a known resource of the known resources; and in response to the determination: updating a record associated with the known resource based on one or more conditions of the resource.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a diagram of a backup management system in accordance with one or more embodiments of the invention.

FIG. 3 shows a diagram of a discovered resource repository in accordance with one or more embodiments of the invention.

FIG. 4 shows a flowchart of a method of providing data protection services in accordance with one or more embodiments of the invention.

FIGS. 5.1-5.3 show diagrams of the operation of a system similar to that of FIG. 1 over time in accordance with one or more embodiments of the invention.

FIG. 6 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

In general, embodiments of the invention relate to systems, devices, and methods for providing data protection services. Data protection services may include storage of information usable to restore a resource after a device hosting the resource has become inoperable, unresponsive, etc. The data protection services may be provided in a manner to comply with data protection goals, policies, etc.

To provide data protection services, resources that may need to be protected may be discovered. To discover the resources, agents hosted by the devices that host the resources may enumerate the resources, obtain information regarding the resources, and may provide the information and enumeration to a backup management entity. However, because the devices that host the resources may identify the resources using identifiers that are not globally unique, the identifiers may be insufficient to determine whether (i) a resource has been previously discovered (e.g., was hosted by a different device and is now hosted by a device performing resource discovery) and (ii) all resources are discovered (e.g., identifiers of multiple resources may collide).

In one or more embodiments of the invention, resource discovery is performed based on natural identifiers of the resources rather than host device assigned identifiers. The natural identifiers may globally uniquely identify the respective resources. Consequently, misidentification of resources may be less likely.

After the resources are discovered, appropriate protection frameworks may be setup for the respective resources. The protection frameworks may include generation of backups or other data structures usable to restore the resources to previous states.

By performing resource discovery based on natural identifiers rather than host device assigned identifiers, needless duplicative backups for the resources may be avoided while ensuring that protection frameworks for the resources are in place. By doing so, a system in accordance with embodiments of the invention may more efficiently marshal limited computing resources to provide desired data protection services.

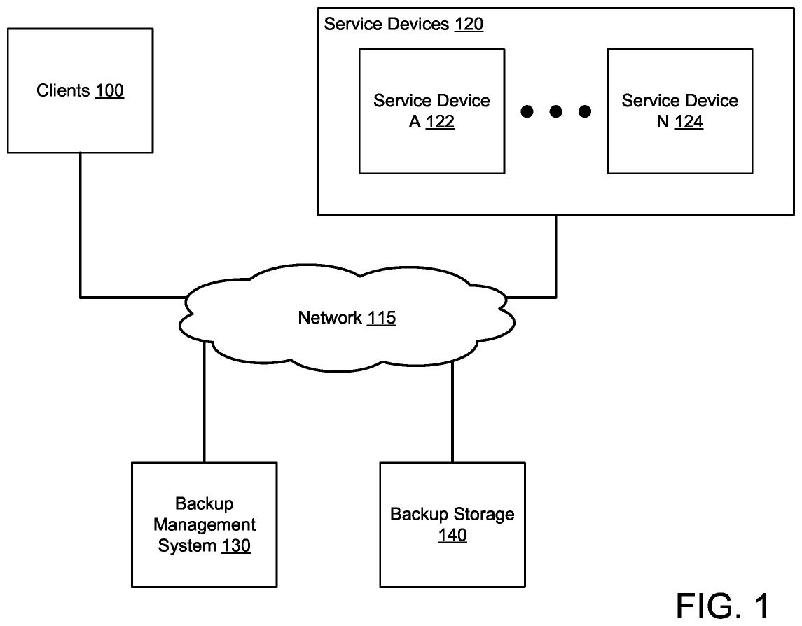

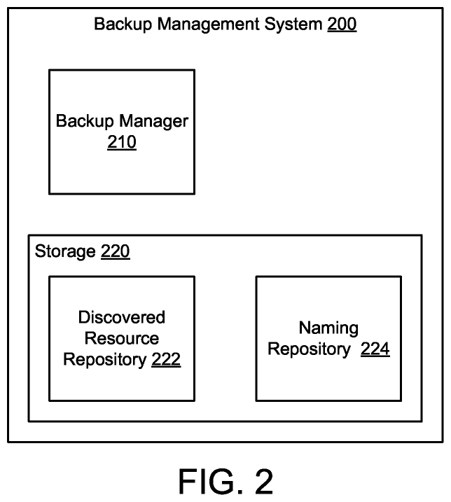

Turning to FIG. 1, FIG. 1 shows a system in accordance with one or more embodiments of the invention. The system may include any number of clients (100). The clients (100) may provide computer implemented services to users of the clients (100) (and/or other devices such as, other clients or other types of devices). The clients (100) may provide any number and type of computer implemented services (e.g., data storage services, electronic communication services, etc.).

To provide computer implemented services, the entities hosted by the clients (e.g., applications) may utilize information from any number of sources. For example, the clients (100) may utilize information stored in service devices (120) operably connected to the clients (100) by one or more networks (e.g., 115). The clients (100) may utilize information from other sources without departing from the invention.

The service devices (120) may provide computer implemented services to the clients (100) and/or other devices. For example, the clients (100) may host databases used to provide database services to the clients. The database services may include storing information in the database and providing information stored in the databases to the clients (100) and/or other entities. The computer implemented services may be other types of services (e.g., electronic communications, video streaming, data analysis, etc.) without departing from the invention.

When the service devices (120) provide computer implemented services to the clients (100), any of the service devices (e.g., 122, 124) may store information that may be relevant to the clients (100). When client relevant data is stored (e.g., locally) by one of the service devices (120), the client relevant data may be subject to loss, inaccessibility, or other undesirable characteristics based on the operation of the service device storing the data.

To mitigate, limit, and/or prevent such undesirable characteristics, the users (e.g., persons, administrators, organization, etc.) of the clients (100) may enter into agreements (e.g., service level agreements) with the users (e.g., persons, administrators, organization, etc.) of the service devices (120). These agreements may limit the potential exposure of client relevant data to undesirable characteristics. The agreements may, for example, require duplication of client relevant data to other locations so that if a service device fails another copy (or other data structure usable to recover the data on the service device) of the client relevant data may be obtained. The agreements may specify other types of activities to be performed with respect to the service devices without departing from the invention.

To meet the requirements of these agreements, the resources hosted by the services devices that include client relevant data may need to be identified. To do so, the resources hosted by the service devices (120) may be inventoried. The inventoried resources may be cataloged so that an administrator or automated entities may view and setup protection frameworks (e.g., backup generation in accordance with a schedule or other condition) for the resources that are governed by the agreements.

However, as resources are moved between locations (e.g., service devices), are instantiated in new service devices following failures of service devices, and/or for other reasons, it may be difficult to keep track of which resources have already been inventoried.

For example, while each of the service devices may be able to individually identify their respective resources, it may not be possible from the naming conventions and identifiers utilized by these service devices (120) for identification purposes to identify whether a resource has already been inventoried.

Consequently, if an already-inventoried resource is re-inventoried as a new resource, the corresponding backup frameworks setup to provide data protection services for the inventoried resources may be needlessly duplicative and/or may fail to provide appropriate levels of data protection for the resources.

In general, embodiments of the invention relate to systems, devices, and methods for providing data protection services for resources. Service embodiments of the invention may provide a method for inventorying resources hosted by the services devices (120) (and/or other devices) in a manner that enables the resources to be globally tracked over time. By doing so, needless duplication of backups may be avoided while improving the likelihood that appropriate backups (or other data structures able to restore resources governed by the agreements) are generated for the resources.

To do so, a backup management system (130) that provides the data protection services may utilize natural identifiers for inventorying resources of the service devices. A natural identifier may be a data structure based on a natural key of the resource. The natural key of the resource may be unique across all resources of each resource type.

In one or more embodiments of the invention, a resource is associated with multiple natural identifiers. Each of the natural identifiers for the resource may be based on (i) a type of the resource and (ii) a subset of attributes ascribed to the resource by the service device that hosts the resource. The attributes ascribed to the resource may include, for example, a name of the resource, a globally unique identifier for the resource type, and/or other identifiers that are consistent when the resource is moved between hosting by different service devices.

By inventorying resources based on natural identifiers, previously inventoried resources may be identified regardless of where the resource is hosted over time. Consequently, when a resource is moved to a new service device and inventoried, the system may automatically put in place the same protection framework for the resource at its new location. Accordingly, backups (or other data structures) for the resource may be consistently generated over time thereby improving the likelihood that the data protection services provided to the resource meet the requirements of the agreements governing the data protection services. For additional details regarding the backup management system (130), refer to FIG. 2.

The backup storage (140) may provide backup storage services. The backup storage services may include storing backups from the service devices (and/or other entities) and/or providing copies of the backups and/or information derived from the stored backups to other entities. Such backups may be utilized to perform restorations of the service devices (120) (and/or other entities). Accordingly, as the resources are transitioned between different service devices, corresponding backups for the resources may continue to be generated, stored, and used to restore the resources regardless of their current location.

Further, because duplicative backups are unlikely to be generated, the process of performing a restoration may be simplified by reducing the number of backups usable to perform a restoration and ensuring that all backups usable to perform a restoration are taken into account. For example, in a scenario in which an administrator is orchestrating a restoration, a graphical user interface may present the available restorations that may be performed using the backups. A system in accordance with embodiments of the invention may provide a simplified interface by reducing the number of restoration options by avoiding duplicative generation of backups on which the restoration options may be based.

A restoration may be a process of modifying the operation of a device (e.g., a service device that has failed, another device, etc.) to operate in accordance with a previous state of a service device or another device. To restore a device, a new instance of the device may be generated (e.g., by loading software onto a computing device). Data, based on one or more backups stored in the backup storage (140), may be made accessible to the software. The data may be associated with the previous state to which the device is being restored. Consequently, the software may begin using the data thereby causing the software to operate in accordance with the previous state. The backups stored in the backup storage (140) may be usable to restore devices to any number of previous states without departing from the invention.

The backup storage (140) may be independent (and/or may be in a different fault domain) from the service devices (120) (and/or other devices for which the backup storage (140) stores backups). Consequently, a failure of a service device may be less likely to impact the ability of the backup storage (140) to provide its services. For example, the backup storage (140) may be stored in a different geographic location with respect to the locations of the service devices (120), may be implemented as a different device in a data center in which the service devices (120) reside, etc.

The system of FIG. 1 may include any number of clients (100), services devices (120), backup management systems (e.g., 130), and backup storages (e.g., 140). Any of the components of FIG. 1 may be operably connected to any other component and/or other components not illustrated in FIG. 1 via one or more networks (e.g., 115). The networks (e.g., 115) may be implemented using any combination of wired and/or wireless network topologies. The networks may employ any number and types of communication schemes to enable the clients (100), service devices systems (e.g., 120), backup management systems (e.g., 130), and backup storages (e.g., 140) to communicate with each other.

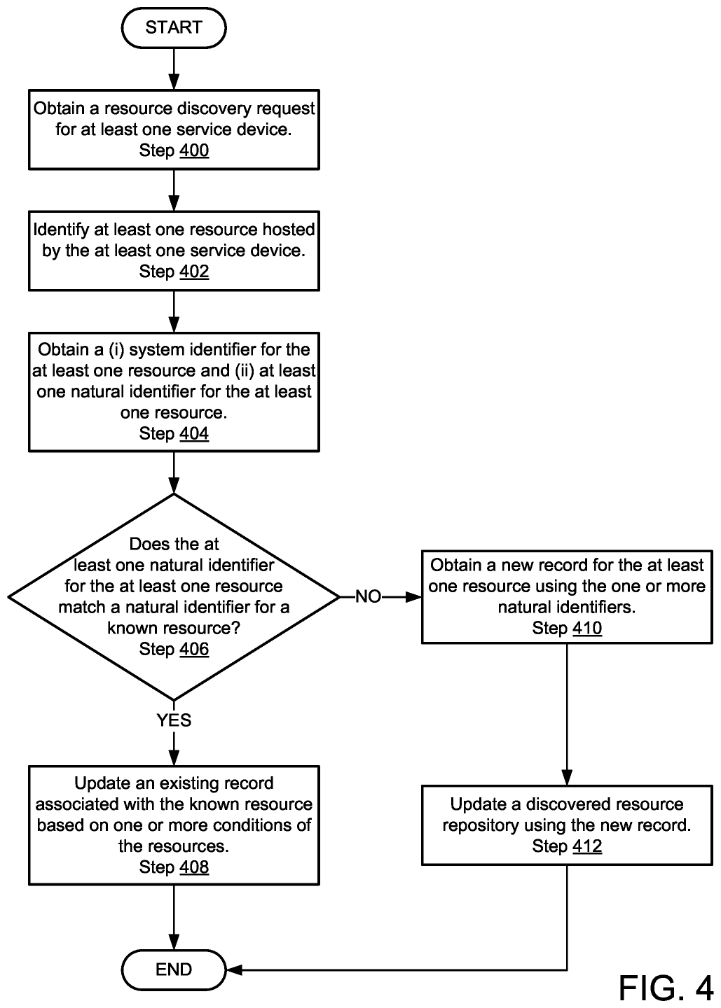

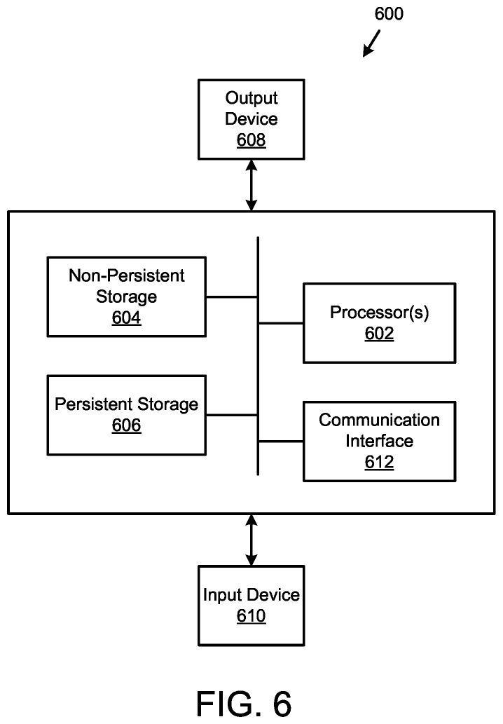

The clients (100), service devices systems (e.g., 120), backup management systems (e.g., 130), and backup storages (e.g., 140) may be implemented using computing devices. The computing devices may include, for example, a server, laptop computer, a desktop computer, a node of a distributed system, etc. (e.g., one or more being part of an information handling system). The computing device may include one or more processors, memory (e.g., random access memory), and/or persistent storage (e.g., disk drives, solid state drives, etc.). The persistent storage may store computer instructions, e.g., computer code, that (when executed by the processor(s) of the computing device) cause the computing device to perform the functions of the clients (100), service devices systems (e.g., 120), backup management systems (e.g., 130), and/or backup storages (e.g., 140) described in this application and/or all, or a portion, of the method illustrated in FIG. 4. The clients (100), service devices systems (e.g., 120), backup management systems (e.g., 130), and backup storages (e.g., 140) may be implemented using other types of computing devices without departing from the invention. For additional details regarding computing devices, refer to FIG. 6.

While the system of FIG. 1 has been illustrated and described as including a limited number of specific components, a system in accordance with embodiments of the invention may include additional, fewer, and/or different components without departing from the invention.

Turning to FIG. 2, FIG. 2 shows a diagram of a backup management system (200) in accordance with one or more embodiments of the invention. The system of FIG. 1 may include any number of backup management systems (e.g., 130) similar to the backup management system (200) illustrated in FIG. 2. The backup management system (200) may provide data protection services for any number of resources hosted by any number of services devices (e.g., all or a portion of the service devices illustrated in FIG. 1).

To provide data protection services, the backup management system (200) may include a backup manager (210) and storage (220). Each of these components is discussed below.

The backup manager (210) may orchestrate the data protection services. The data protection services may include (i) inventorying service devices to identify resources that are to be protected, (ii) establishing protection frameworks for the inventoried resources, (iii) obtaining backups for the resources in accordance with the protection frameworks, (iv) storing the backups in backup storage for future use, and (v) using the obtained backups to restore the resources to previous states or for other uses (e.g., obtaining copies of older data).

To inventory the service devices, the backup manager (210) may utilize agents hosted by the service devices. The agents hosted by the service devices may (i) enumerate resources (e.g., databases, other types of data structures) hosted by the service devices, (ii) obtain information regarding the service devices usable to obtain natural identifiers for the resources, and (iii) provide the information and/or natural identifiers for the resources to the backup manager (210).

To utilize the agent, the backup manager (210) may program the agent based on sets of rules for generating the natural identifiers stored in a naming repository (224). By doing so, the agents may be able to obtain appropriate information to generate natural identifiers and/or the natural identifiers.

The backup manager (210) may program the agent using any command and control scheme (e.g., message passing, publish-subscribe, etc.) without departing from the invention. As used herein, programming an agent may refer to a process of providing information to an agent that modifies the operation of the agent. For example, the backup manager (210) may provide a backup schedule and/or information regarding a backup schedule to cause the agent to be programmed to initiate generation of backups by a service device in accordance with the backup schedule.

The backup manager (210) may use information obtained from the agents to (i) identify whether inventoried resources are known resources and (ii) generate new records for new resources. The records may be stored in a discovered resource repository (222).

To provide data protection services, the backup manager (210) may establish protection frameworks (e.g., backup generation schedules, policies, and/or other information that governs when and how backups for known resources are generated) for the resources. The backup manager (210) may initiate backup generations in accordance with the protection frameworks using, for example, the agents hosted by the service devices.

When providing its functionality, the backup manager (210) may perform all, or a portion, of the method illustrated in FIG. 4.

In one or more embodiments of the invention, the backup manager (210) is implemented using a hardware device including circuitry. The hardware device may be, for example, a digital signal processor, a field programmable gate array, or an application specific integrated circuit. The circuitry may be adapted to cause the hardware device to perform the functionality of the backup manager (210). The backup manager (210) may be implemented using other types of hardware devices without departing from the invention.

In one or more embodiments of the invention, the backup manager (210) is implemented using a processor adapted to execute computing code stored on a persistent storage that when executed by the processor performs the functionality of the backup manager (210). The processor may be a hardware processor including circuitry such as, for example, a central processing unit or a microcontroller. The processor may be other types of hardware devices for processing digital information without departing from the invention.

As used herein, an entity that is programmed to perform a function (e.g., step, action, etc.) refers to one or more hardware devices (e.g., processors, digital signal processors, field programmable gate arrays, application specific integrated circuits, etc.) that provide the function. The hardware devices may be programmed to do so by, for example, being able to execute computer instructions (e.g., computer code) that cause the hardware devices to provide the function. In another example, the hardware device may be programmed to do so by having circuitry that has been adapted (e.g., modified/created) to perform the function. Computer instructions may be used to program a hardware device that, when programmed, provides the function.

In one or more embodiments disclosed herein, the storage (220) is implemented using physical devices that provide data storage services (e.g., storing data and providing copies of previously stored data). The devices that provide data storage services may include hardware devices and/or logical devices. For example, storage (220) may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, storage (220) may include a memory device (e.g., a dual in line memory device) in which data is stored and from which copies of previously stored data are provided. In another example, storage (220) may include a persistent storage device (e.g., a solid-state disk drive) in which data is stored and from which copies of previously stored data is provided. In a still further example, storage (220) may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

The storage (220) may also be implemented using logical storage. A logical storage (e.g., virtual disk) may be implemented using one or more physical storage devices whose storage resources (all, or a portion) are allocated for use using a software layer. Thus, a logical storage may include both physical storage devices and an entity executing on a processor or other hardware device that allocates the storage resources of the physical storage devices.

The storage (220) may store data structures including, for example, a discovered resource repository (222) and/or a naming repository (224). Each of these data structures is discussed below.

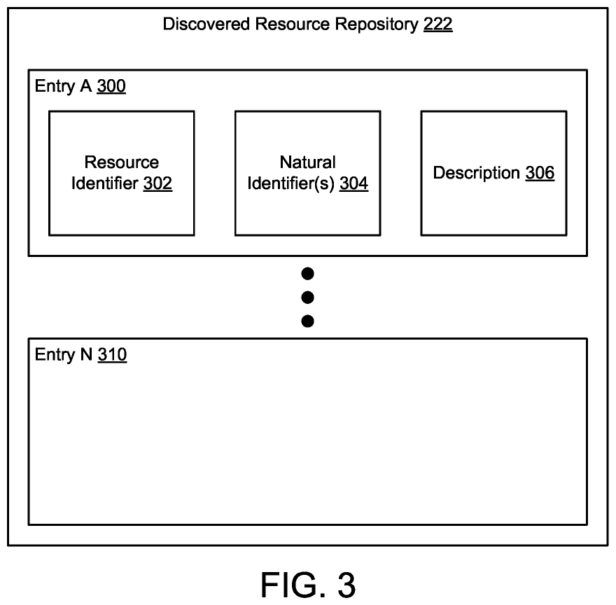

The discovered resource repository (222) may be implemented using one or more data structures that includes information regarding known resources. The information may include, for example, natural identifiers associated with the respective resources. For additional information regarding the content of the discovered resource repository (222), refer to FIG. 3.

The backup manager (210) may use the information included in the discovered resource repository (222) to setup protection frameworks. For example, the backup manager (210) may use the information to identify whether an inventoried resource is a known resource and, if the resource is unknown, add information to the discovered resource repository (222) regarding the unknown resource. By doing so, the backup manager (210) may setup a protection framework for the now-known resource.

The discovered resource repository (222) may be maintained by, for example, the backup manager (210). For example, the backup manager (210) may add, remove, and/or modify information included in the discovered resource repository (222). The backup manager (210) may do so based on information obtained from agents hosted by the service devices.

The data structures of the discovered resource repository (222) may be implemented using, for example, lists, tables, unstructured data, databases, etc. While illustrated in FIG. 2 as being stored locally, the discovered resource repository (222) may be stored remotely and may be distributed across any number of devices without departing from the invention.

The naming repository (224) may be implemented using one or more data structures that includes information regarding the generation of natural identifiers. For example, the naming repository (224) may specify actions and/or rules (e.g., action sets) to be performed to generate natural identifiers. The naming repository (224) may include any number of such actions/rules for generating natural identifiers for any number of types of resources without departing from the invention.

The action may specify, for example, which types of information regarding a resource are to be used to generate a natural identifier and how to generate the natural identifier using the information.

In one or more embodiments of the invention, the naming repository (224) specifies that, to generate a natural identifier, a subset of the information used by a system to identify a resource is to be appended to another attribute ascribed to the resource by the system in a predetermined order to form a data structure. The naming repository (224) may further specify that the data structure is to be mapped to a predetermined size data structure (e.g., using any type of mapping function). The naming repository (224) may further specify that a hash of the predetermined size data structure is generated as a body of the natural identifier. The naming repository (224) may further specify that a rank for the body be appended to the body to obtain a natural identifier of the rank appended to the body.

The naming repository (224) may be maintained by, for example, the backup manager (210). For example, the backup manager (210) may add, remove, and/or modify information included in the naming repository (224) (e.g., as specified, for example, by an administrator or other person).

The data structures of the naming repository (224) may be implemented using, for example, lists, tables, unstructured data, databases, etc. While illustrated in FIG. 2 as being stored locally, the naming repository (224) may be stored remotely and may be distributed across any number of devices without departing from the invention.

While the storage (220) has been illustrated and described as including a limited number and type of data, a storage in accordance with embodiments of the invention may store additional, less, and/or different data without departing from the invention.

While the backup management system (200) has been illustrated and described as including a limited number of specific components, an information handling system in accordance with embodiments of the invention may include additional, fewer, and/or different components without departing from the invention.

Turning to FIG. 3, FIG. 3 shows a diagram of a discovered resource repository (222) in accordance with one or more embodiments of the invention. The discovered resource repository (222) may store information regarding known resources.

In one or more embodiments of the invention, the discovered resource repository (222) include entries (e.g., 300, 310). Each entry may be associated with a known resource.

Each entry may include one or more of a resource identifier (302), one or more natural identifiers (304), and a description.

The resource identifier (302) may be an identifier ascribed to the known resource associated with the entry by a service device that hosts the known resource. The resource identifier (302) may be, for example, a globally unique identifier or other type of identifier that allows the service device to discriminate the known resources from other known resources of a similar type.

The natural identifiers (304) may be one or more natural identifiers associated with the known resource associated with the entry. Each of the natural identifiers may be ranked (e.g., a portion of the natural identifiers may indicate the respective ranks or a separate data structure may indicate the respective ranks) with respect to each other.

The description (306) may include information regarding the known resource associated with the entry such as, for example, a name of the resource ascribed to it by a service device that hosts the resource. The description (306) may include additional, different, and/or less information regarding the resource associated with the entry without departing from the invention.

As discussed above, the system of FIG. 1 may provide data protection services. FIG. 4 illustrates a method that may be performed by components of the system of FIG. 1 to provide data protection services.

FIG. 4 shows a flowchart of a method in accordance with one or more embodiments of the invention. The method depicted in FIG. 4 may be performed to provide data protection services in accordance with one or more embodiments of the invention. The method shown in FIG. 4 may be performed by, for example, a backup management system (e.g., 130, FIG. 1). Other components of the system in FIG. 1 may perform all, or a portion, of the method of FIG. 4 without departing from the invention.

While FIG. 4 is illustrated as a series of steps, any of the steps may be omitted, performed in a different order, additional steps may be included, and/or any or all of the steps may be performed in a parallel and/or partially overlapping manner without departing from the invention.

In step 400, a resource discovery request for at least one service device is obtained.

In one or more embodiments of the invention, the discovery request is obtained from an administrator or other person. The request may specify that data protection services are to be provided for the at least one service device.

The discovery request may be obtained via other methods without departing from the invention. For example, the backup management system may automatically at a predetermined point in time, in response to the occurrence of one or more events, or for other reasons, perform discovery for the at least one service device. The discovery request may be for new service devices (e.g., devices for which discovery has not been performed previously) and/or managed service devices (e.g., devices for which the backup management system has already performed discovery).

In step 402, at least one resource hosted by the at least one service device is identified.

In one or more embodiments of the invention, the at least one resource is discovered using an agent hosted by the at least one service device. The agent may enumerate the resources hosted by the service device and provide information regarding the enumerated resources to the backup management system to enable the backup management system to identify the at least one resource.

In one or more embodiments of the invention, the agent, on behalf of the data management system, performs the aforementioned actions in accordance with programming by the backup management system. For example, the backup management system may program the agent (e.g., a program executing using computing resources of the service device) by providing the agent and/or other entities hosted by the service device with information regarding (i) types of assets to be inventoried, (ii) desired types of information regarding the assets, and/or (iii) information regarding how to obtain natural identifiers for the types of assets (e.g., information included in the naming repository).

The backup management system may manage the operation of the agent using any command and control system such as, for example, message passing, publish-subscribe, state sharing, etc. The backup management systems may utilize different modalities for managing the operation of the agent without departing from the invention.

In step 404, a system identifier for the at least one resource and at least one natural identifier for the at least one resource is obtained.

The aforementioned identifiers may be obtained using the agent. For example, the agent may collect the identifiers, generating the natural identifier, and/or collect information usable to generate the natural identifier. Once collected, the agent may provide the identifiers and/or information usable to obtain the identifiers to the backup management system.

The agent may do so by, for example, sending the identifiers and/or information usable to obtain the identifiers using one or more messages. The messages may be sent to the backup management system via one or more networks. The agent may send the identifiers and/or information usable to obtain the identifiers via other methods without departing from the invention. For example, the identifiers and/or information may be stored in a predetermined location (e.g., cloud data) accessible by the backup management system, may publish the identifiers and/or information via a subscription system to which the backup management system is subscribed, etc.

In step 406, it is determined whether the at least one natural identifier for the at least one resource matches a natural identifier for a known resource.

In one or more embodiments of the invention, the determination is made by matching the at least one natural identifier (e.g., obtained in step 404) against natural identifiers included in a discovered resource repository. If the at least one natural identifier matches one of the included natural identifiers, it may be determined that the natural identifier matches a natural identifier for a known resource.

If it is determined that the natural identifier matches any natural identifier associated with the known resources, then the method may proceed to step 408. In other words, if the at least one natural identifier had been previously encountered and recorded, then it is presumed that the identified at least one resource (e.g., step 402) is a known resource and should not be treated as a new resource that requires additional action to provide it with appropriate data protection.

Otherwise, the method may proceed to step 410 following step 406. In other words, if the at least one natural identifier had not been previously encountered and recorded, then it is presumed that the at least one resource should be treated as a new resource that requires additional action to provide it with appropriate data protection.

In step 408, an existing record associated with the known resource is updated based on one or more conditions of the resource.

In one or more embodiments of the invention, the existing record (e.g., entry) is the record of the discovered resource repository that stores the matched natural identifier in step 406. The record may be updated by modifying the data in the record based on the one or more conditions of the resource.

For example, the description of the existing record may be updated to reflect the location of the resource, the name of the resource, and/or any other types of information regarding the resource. By doing so, as resources move locations, change names, and/or undergo other transformations, the backup management system may keep records of their current conditions. The aforementioned information may be used, for example, when performing restorations of the service devices and/or for other purposes.

In one or more embodiments of the invention, other fields of the existing record may also be updated. For example, if new/additional natural identifiers of the resource are identified (beyond those already stored in the record), then the record may be updated to reflect these new natural identifiers. Such new natural identifiers may exist when the rules for generating natural identifiers change, when the resource changes (e.g., when new identifiers are added for additional identification purposes), and/or due to other changes.

The method may end following step 408.

Returning to step 406, the method may proceed to step 410 following step 406 when it is determined that the at least one natural identifier does not match any natural identifier for the known resources.

In step 410, a new record for the at least one resource is obtained using the one or more natural identifiers.

The new record may be obtained by adding a new entry to the discovered resource repository. The new record may include all, or portion, of the information included in records as described with respect to FIG. 3.

In step 412, a discovered resource repository is updated using the new record. The discovered resource repository may be updated by adding the new record to it or by adding information to the discovered resource repository based on the new record.

The method may end following step 412.

Using the method illustrated in FIG. 4, a system in accordance with embodiments of the invention may reduce the likelihood of needlessly generating duplicative backups while ensuring appropriate backups for resources are generated to meet data protection requirements (e.g., specified by agreements).

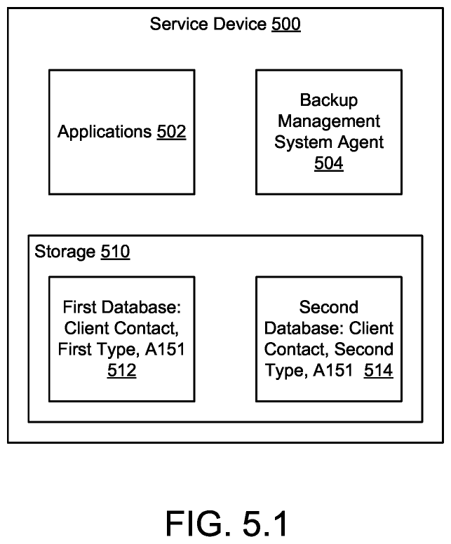

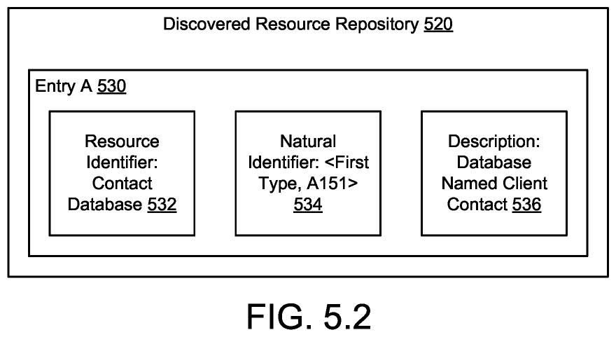

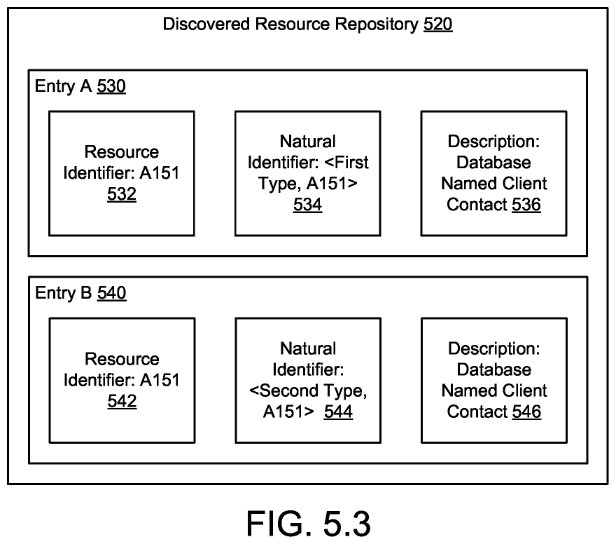

To further clarify embodiments of the invention, a non-limiting example is provided in FIGS. 5.1-5.3. FIG. 5.1 shows a diagram of an example of a service device (500) hosting resources for which a backup management system (not shown) will provide data protection services. FIGS. 5.2-5.3 show diagrams of a portion of the discovered resource repository (520) used by the backup management system as various resources of the service device (500) are discovered.

### EXAMPLE

Consider a scenario in which a service device as shown in FIG. 5.1 provides database services for a consulting agency. To do so, the service device (500) hosts applications (502) that provide the database services. When providing the services, the applications (502) store information from the consulting agency in a first database (512) and a second database (514) both stored in storage (510) of the service device (500).

The information included in these databases are of high business value to the consulting agency and, consequently, requires that backups for the databases need to be stored in backup storage.

However, both of these databases are named, by the operators of the service device (500), as “client contact” because both store client contact information for the consulting agency. Further, the two databases are of different types (e.g., first type and second type) which results in the same identifier of A151 (for the purposes of this example, the phrase A151 is chosen arbitrarily, in practice globally unique identifiers for each database type may be used) being assigned to both databases by the service device (500). Consequently, if either of the name or identifier is used when inventorying the service device (500), one of these databases may be viewed as a redundant copy or the same as the other thereby not needing data protection services.

However, as discussed above, a backup management system in accordance with embodiments of the invention may utilize natural identifiers for inventory purposes.

To inventory the service device (500), the backup management system programs a backup management system agent (504) hosted by the service device (500) to obtain information usable to inventory the service device (500). The backup management system agent (504) does so by obtaining and providing the information to the backup management system.

Turning to FIG. 5.2, the backup management system agent first provides the backup management system with information regarding the first database. The backup management system begins by constructing a natural identifier for the first database by appending the type of the first database (e.g., “first type”) to the globally unique identifier assigned to the first database by the service device (e.g., “A151”) to obtain a string. The backup management system then maps the string to a fixed number of bits and then hashes the fixed length number of bits to obtain the natural identifier. The backup management system then compares the natural identifier to natural identifiers included in the discovered resource repository (520) and determines that none match. Accordingly, the backup management system next generates a new record for the first database.

To do so, the backup management system generates entry A (530) which includes the resource identifier (532) of “contact database”, the natural identifier (534) as generated above (in FIG. 5.2, the natural identifier is shown as “<First Type, A151>” to indicate that the natural identifier is a hash of the mapped string “First TypeA151”), and the description (536) of “Database Named Client Contact”.

Turning to FIG. 5.3, the backup management system agent next provides the backup management system with information regarding the second database. The backup management system begins by constructing a natural identifier for the second database by appending the type of the second database (e.g., “second type”) to the globally unique identifier assigned to the second database by the service device (e.g., “A151”) to obtain a second string. The backup management system then maps the second string to a second fixed number of bits and then hashes the second fixed length number of bits to obtain the second natural identifier. The backup management system then compares the second natural identifier to natural identifiers included in the discovered resource repository (520) and determines that none match. For example, the second natural identifier associated with the second database is different from the natural identifier (534) of entry A (530) by virtue of the difference between “first type” and “second type”. Accordingly, the backup management system next generates a second new record for the second database.

To do so, the backup management system generates entry B (540) which includes the resource identifier (542) of “contact database”, the natural identifier (544) as generated above (in FIG. 5.3, the natural identifier is shown as “<Second Type, A151>” to indicate that the natural identifier is a hash of the mapped string “Second TypeA151”), and the description (546) of “Database Named Client Contact”.

By adding the new entries as discussed above, the backup management system may automatically take action to setup appropriate protection frameworks to provide data protection services for these newly inventoried resources. Additionally, as these databases move between hosting by different service devices, the databases will consistently be associated with the same natural identifiers. Consequently, movement of the databases will not cause duplicative backups or backup failures to occur by virtue of ambiguity between of whether newly discovered instances of the database are the same as those already known to the backup management system.

### END OF EXAMPLE

As discussed above, embodiments of the invention may be implemented using computing devices. FIG. 6 shows a diagram of a computing device in accordance with one or more embodiments of the invention. The computing device (600) may include one or more computer processors (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (612) (e.g., Bluetooth interface, infrared interface, network interface, optical interface, etc.), input devices (610), output devices (608), and numerous other elements (not shown) and functionalities. Each of these components is described below.

In one embodiment of the invention, the computer processor(s) (602) may be an integrated circuit for processing instructions. For example, the computer processor(s) may be one or more cores or micro-cores of a processor. The computing device (600) may also include one or more input devices (610), such as a touchscreen, keyboard, mouse, microphone, touchpad, electronic pen, or any other type of input device. Further, the communication interface (612) may include an integrated circuit for connecting the computing device (600) to a network (not shown) (e.g., a local area network (LAN), a wide area network (WAN) such as the Internet, mobile network, or any other type of network) and/or to another device, such as another computing device.

In one embodiment of the invention, the computing device (600) may include one or more output devices (608), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (602), non-persistent storage (604), and persistent storage (606). Many different types of computing devices exist, and the aforementioned input and output device(s) may take other forms.

Embodiments of the invention may provide a system and method for providing data protection services. Specifically, embodiments of the invention may provide methods for inventorying devices on which resources that may receive the data protection services may reside. To do so, the system may inventory the devices based on natural identifiers of the resources. By doing so, the system may be less likely to misidentify resources as being previously known or unknown when the contra is true.

Thus, embodiments of the invention may address the problem of misidentification of resources in a distributed system that utilizes non-unique identifiers for resource identification purposes.

The problems discussed above should be understood as being examples of problems solved by embodiments of the invention and the invention should not be limited to solving the same/similar problems. The disclosed invention is broadly applicable to address a range of problems beyond those discussed herein.

One or more embodiments of the invention may be implemented using instructions executed by one or more processors of a computing device. Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments can be devised which do not depart from the scope of the invention. Accordingly, the scope of the invention should be limited only by the attached claims.

What is claimed is:

1. A backup management system for providing data protection services to service devices that provide computer implemented services for clients and host resources used to provide the computer implemented services to the clients, comprising:
storage for storing:
a discovered resource repository that specifies known resources of the resources; and
a naming repository that specifies how natural identifiers are generated; and
a processor programmed to:
obtain a resource discovery request for a service device of the service devices;
in response to obtaining the resource discovery request:
identify a resource of a portion of the resources hosted by the service device; obtain:
a system identifier used by the service device to identify the resource, and
a natural identifier of the natural identifiers for the resource using the naming repository;
make a determination that the natural identifier matches a second natural identifier associated with a known resource of the known resources; and
in response to the determination:
update a record of the discovered resource repository associated with the known resource based on one or more conditions of the resource.

2. The backup management system of claim 1, wherein the processor is further programmed to:
obtain a second resource discovery request for the service device;
in response to obtaining the resource discovery request:
identify a second resource of the portion of the resources hosted by the service device;
obtain:
a system identifier for the second resource, and
a third natural identifier of the natural identifiers for the second resource using the naming repository;
make a second determination that the third natural identifier does not match any natural identifier associated with any of the known resources; and
in response to the second determination:
obtain a new record for the second resource using the third natural identifier; and
update the discovered resource repository based on the new record.

3. The backup management system of claim 1, wherein the record comprises:
the system identifier for the resource used by the service device to distinguish the resource from other resources of a same type of resource that the service device hosts.

4. The backup management system of claim 3, wherein the record further comprises:
the natural identifier; and
a lower ranked natural identifier for the resource.

5. The backup management system of claim 4, wherein the natural identifier is based on:
a type of the resource; and
a first subset of attributes ascribed to the resource by the service device.

6. The backup management system of claim 5, wherein the lower ranked natural identifier is based on:
the type of the resource, and
a second subset of the attributes ascribed to the resource by the service device,
wherein the first subset of the attributes and the second subset of the attributes are partially overlapping subsets of the attributes.

7. The backup management system of claim 1, wherein the discovered resource repository comprises a listing of the known resources and natural identifiers associated with the known resources.

8. The backup management system of claim 1, wherein making the determination comprises:
for a first known resource of the known resources:
making a first comparison between a highest ranked natural identifier of the natural identifiers associated with the first known resource and the natural identifier;
making a second determination, based on the first comparison, that the highest ranked natural identifier is different from the natural identifier;
in response to the second determination:
making a second comparison between a second highest ranked natural identifier of the natural identifiers associated with the first known resource and the natural identifier;
making a third determination, based on the second comparison, that the second highest ranked natural identifier of the natural identifiers matches the natural identifier; and
making the determination based on the third determination.

9. The backup management system of claim 1, wherein the naming repository specifies action sets for generating the natural identifiers based on a type of each of the resources.

10. The backup management system of claim 9, wherein each of the action sets comprises:
generating a hash value for a data structure based on attributes of the resources; and
appending, to the hash value, a rank that specifies a preference for the hash value over other hash values.

11. A method for providing data protection services to service devices that provide computer implemented services for clients and host resources used to provide the computer implemented services to the clients, comprising:
obtaining a resource discovery request for a service device of the service devices;
in response to obtaining the resource discovery request:
identifying a resource of a portion of the resources hosted by the service device;
obtaining:
a system identifier for the resource, and
a natural identifier for the resource;
making a determination that the natural identifier matches a second natural identifier associated with a known resource of the known resources; and
in response to the determination:
updating a record associated with the known resource based on one or more conditions of the resource.

12. The method of claim 11, further comprising:
obtaining a second resource discovery request for the service device;
in response to obtaining the second resource discovery request:
identifying a second resource of the portion of the resources hosted by the service device;
obtaining:
a system identifier for the second resource, and
a third natural identifier for the second resource;
making a second determination that the third natural identifier does not match any natural identifier associated with any known resource; and
in response to the second determination:
obtaining a new record for the second resource using the third natural identifier; and
storing the new record.

13. The method of claim 11, wherein the record comprises:
a system identifier for the resource used by the service device to distinguish the resource from other resources of a same type of resource that the service device hosts.

14. The method of claim 13, wherein the record further comprises:
the natural identifier; and
a lower ranked natural identifier for the resource.

15. The method of claim 14, wherein the natural identifier is based on:
a type of the resource; and
a first subset of attributes ascribed to the resource by the service device.

16. A non-transitory computer readable medium comprising computer readable program code, which when executed by a computer processor enables the computer processor to perform a method for providing data protection services to service devices that provide computer implemented services for clients and host resources used to provide the computer implemented services to the clients, the method comprising:
obtaining a resource discovery request for a service device of the service devices;
in response to obtaining the resource discovery request:
identifying a resource of a portion of the resources hosted by the service device;
obtaining:
a system identifier for the resource, and
a natural identifier for the resource;
making a determination that the natural identifier matches a second natural identifier associated with a known resource of the known resources; and
in response to the determination:
updating a record associated with the known resource based on one or more conditions of the resource.

17. The non-transitory computer readable medium of claim 16, wherein the method further comprises:
obtaining a second resource discovery request for the service device;
in response to obtaining the second resource discovery request:
identifying a second resource of the portion of the resources hosted by the service device;
obtaining:
a system identifier for the second resource, and
a third natural identifier for the second resource;
making a second determination that the third natural identifier does not match any natural identifier associated with any known resource; and
in response to the second determination:
obtaining a new record for the second resource using the third natural identifier; and
storing the new record.

18. The non-transitory computer readable medium of claim 16, wherein the record comprises:
a system identifier for the resource used by the service device to distinguish the resource from other resources of a same type of resource that the service device hosts.

19. The non-transitory computer readable medium of claim 18, wherein the record further comprises:
the natural identifier; and
a lower ranked natural identifier for the resource.

20. The non-transitory computer readable medium of claim 19, wherein the natural identifier is based on:
a type of the resource; and
a first subset of attributes ascribed to the resource by the service device.
